(19) United States
(12) Patent Application Publication
(10) Pub. No.: US 2008/0174518 A1
(43) Pub. Date: Jul. 24, 2008

(54) Display state controller, display device, display state control method, program therefor, and recording medium recorded with the program

(75) Inventor: Kazuhide Sakuragi, Tokyo (JP)

Correspondence Address: Armstrong, Kratz, Quintos,;Hanson & Brooks, LLP, Suite 1000, 1725 K Street, N.W., Washington, DC, 20006, US

(73) Assignee: PIONEER CORPORATION, Tokyo (JP)

(21) Appl. No.: 11/785,467

(22) Filed: Apr. 18, 2007

(30) Foreign Application Priority Data
Apr. 19, 2006 (JP) 2006-115729

(51) Int. Cl. G09G 1/16

(52) U.S. Cl. 345/10

(57) ABSTRACT

Provided is a display device for executing processing of enlarging a predetermined region (200) of an image rightward by as much as 0.25 pixels with a first pixel (251) as a reference, and processing of reducing the predetermined region (200) rightward 0.25 pixels with a seventh pixel (257) as a reference, to thereby control the predetermined region (200) to be shifted rightward. The image is thus shifted while changing a magnitude of the predetermined region (200) so that an enlarged amount and a reduced amount per one step are smaller than 1 pixel, thereby making it possible to shift the image while changing the magnitude of the image without giving a visually unnatural impression. The display device can be applied to processing using digital signals because a lighting state of each pixel is controlled. The shift of the image can be easily performed without executing pixel conversion processing or the like. The shift is performed while changing the magnitude of the image, which suppresses blurring of the entire image as compared with a structure for shifting the image without changing the magnitude of the image.

### BACKGROUND OF THE INVENTION

1. Field of the Invention

The present invention relates to a display state controller for controlling a display state of an image corresponding to an input image signal, a display device, a display state control method, a program therefor, and a recording medium recorded with the program.

2. Description of the Related Art

In recent years, as a large display has become more popular, a display device has been used not only for displaying a moving image such as a TV picture but also used increasingly for a variety of applications.

For example, by taking advantage of its large screen, the display device has been used increasingly in many cases so as to display a still image for a certain period of time as a display for point-of-sale advertisement or as a screen for displaying information at a station or a service area.

In a display device such as a plasma display panel (PDP) or a cathode-ray tube (CRT), it is known that a burn-in phenomenon occurs when an image is displayed for a certain period of time in the manner as described above.

The burn-in of the screen occurs due to a difference in degrees of deterioration of luminescent materials in a display region having a luminance difference in an image.

In order to deal with the variety of applications of the display device, it is necessary to prevent the burn-in phenomenon from occurring, and various measures against the burn-in phenomenon have been proposed.

As a representative method of preventing the burn-in of the display device, a method of using a screen saver is known. However, the method is not suitable for the display for displaying information because contents of the display need to be changed.

Accordingly, as a generally known method of preventing the burn-in without changing the contents of the display screen, Patent Document 1 (JP 2000-227775 A) discloses a method of periodically shifting a display position of an image in units of pixels.

The technique disclosed in Patent Document 1 has a problem in that the entire image, which is rapidly shifted by as much as one pixel, gives a visually unnatural impression though the shift is made for a long period of time, because the display position of the image is shifted for each predetermined period in units of 1 pixel.

Accordingly, Patent Document 2 (JP 2003-274315 A), Patent Document 3 (JP 2004-264366 A), Patent Document 4 (JP 2005-070226 A), and Patent Document 5 (JP 2005-107132 A) each disclose a technique of shifting a display position of an image without giving a visually unnatural impression to prevent the burn-in by shifting the display position of the image.

In the technique disclosed in Patent Document 2, a time is measured based on a synchronization signal of the image to be displayed, and a phase of the synchronization signal is adjusted to be advanced or delayed in units of a predetermined time period based on the measurement results.

In the technique disclosed in Patent Document 3, pixel conversion is performed with respect to an input signal, and a phase is changed in a unit of change smaller than 360° when the phase between interpolation positions is uniformly set to 360°. Note that, in a case where the pixel conversion is not performed, the phase is not changed.

In the technique disclosed in Patent Document 4, interpolation processing is performed with respect to the input signal based on coefficient information based on a predetermined periodical pattern according to a pixel conversion ratio, and a start position of the coefficient information at that time is made variable, thereby realizing shift of pixels by a shifting amount of less than 1 pixel.

In the technique disclosed in Patent Document 5, the burn-in of the screen can be prevented without changing the image by gradually shifting the display position of the image every predetermined period, and the display position of the image can be shifted without giving a visually unnatural impression by shifting the image in units of sub-pixels in appearance.

As described above, the technique of Patent Document 1 has a problem in that the entire image gives a visually unnatural impression since the entire image is rapidly shifted by as much as 1 pixel.

Further, Patent Document 2, Patent Document 3, Patent Document 4, and Patent Document 5 which have been made in view of the problem inherent in the technique of Patent Document 1 have the following problems.

That is, the technique of Patent Document 2 has a problem in that a smooth shift of a display screen through phase adjustment of a synchronization signal is limited to processing performed at the time of inputting an analog signal, and the shift is performed in units of 1 pixel in the processing performed at the time of inputting a digital signal. There is an increasing demand for higher quality image in recent years, so that it is necessary to perform processing of preventing the burn-in caused at the time of inputting a digital signal, and it is also necessary to have a function of preventing the burn-in which corresponds to both the cases of inputting a digital signal and inputting an analog signal.

The technique of Patent Document 3 has a problem in that processing becomes complicated since pixel conversion processing and processing for shifting an image display position are executed in parallel. For example, when a shifting range of the display position exceeds 1 pixel due to a phase change smaller than 360°, it is difficult to perform processing in a case where coefficient conversion at the moment when the display position exceeds 1 pixel is performed by reading data using a FIFO memory or the like. The technique of Patent Document 3 has another problem in that the pixel conversion must be performed every time when a phase is to be changed since the phase is not changed when the pixel conversion is not performed.

The technique of Patent Document 4 has a problem in that a resolution of a shifting amount within 1 pixel varies depending on enlargement factors since coefficient information based on the predetermined periodical pattern according to the pixel conversion ratio is used. Further, adjacent interpolation points are not aligned in order in some cases depending on the pixel conversion coefficients, which requires to deal with the cases individually, thereby making the processing complicated.

The technique of Patent Document 5 has a problem in that the image blurs while it is possible to shift a display position of an image without giving a visually unnatural impression by shifting the image in units of sub-pixels in appearance.

The above-mentioned points are described in detail with reference to FIG. 1.

FIG. 1 is a diagram showing a state where a display position of an image on one horizontal line is changed with time.

For example, as shown in FIG. 1, as an initial state (state of uppermost stage), it is assumed that pixels 1 displayed in black and pixels 2 displayed in white are alternately aligned on one horizontal line.

When the image is horizontally shifted rightward by as much as 1 pixel from that state, for example, the pixels 2 displayed in white and the pixels 1 displayed in black are alternately aligned as shown in a lowermost stage of FIG. 1.

In the technique of Patent Document 5, in a process of shifting the image from a state shown in the uppermost stage of FIG. 1 to a state shown in the lowermost stage of FIG. 1, the pixels 1 displayed in black are gradually changed to the pixels 2 displayed in white with time as shown in FIG. 1, while the pixels 2 displayed in white are gradually changed to the pixels 1 displayed in black.

Specifically, a pixel on a leftmost side, a pixel in the middle, and a pixel on a rightmost side are respectively changed with time to the pixel 1 displayed in black, a pixel 3 displayed in gray close to black, a pixel 4 displayed in gray between black and white, a pixel 5 displayed in gray close to white, and the pixel 2 displayed in white in the stated order.

To the contrary, a pixel next to the leftmost pixel and a pixel next to the rightmost pixel are respectively changed with time to the pixel 2 displayed in white, the pixel 5 displayed in gray close to white, the pixel 4 displayed in gray between black and white, the pixel 3 displayed in gray close to black, and the pixel 1 displayed in black in the stated order.

In the process, at the exact intermediate point in a time series, that is, for example, in a state shown in the middle stage (third stage from the top) of FIG. 1, all the pixels are changed to the pixels 4 displayed in gray between black and white, which blurs the entire image.

As described above, the technique of Patent Document 1 has a problem in that switching of a screen at the time of shifting the image is visually conspicuous since the image is shifted in units of 1 pixel. The technique of Patent Document 2 has a problem in that the processing is limited to processing using analog signals since measures for preventing the burn-in through phase adjustment of a synchronization signal. The techniques of Patent Document 3 and Patent Document 4 have a problem in that the processing is complicated. Further, the technique of Patent Document 5 has a problem in that an image blurs.

### SUMMARY OF THE INVENTION

In view of the above-mentioned circumstances, a main object of the present invention is to provide a display state controller capable of preventing burn-in of a display unit appropriately and easily, a display device, a display state control method, a program therefor, and a recording medium recorded with the program.

According to an aspect of the present invention, there is provided a display state controller for controlling a display state of an image corresponding to an input image signal, the image being displayed on a display unit that has a plurality of pixels, the display state controller including a shift controller that shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.

According to another aspect of the present invention, there is provided a display device including: a display unit; a display controller that acquires an input image signal and causes the display unit to display an image corresponding to the input image signal; and the display state controller according to the above-mentioned aspect that controls a display state of an image displayed on the display unit.

According to another aspect of the present invention, there is provided a display state control method of controlling, by a calculation unit, a display state of an image displayed on a display unit corresponding to an input image signal, in which the display unit includes a plurality of pixels, and the calculation unit shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.

According to another aspect of the present invention, there is provided a display state control program which causes a calculation unit to execute the display state control method according to the above-mentioned another aspect.

According to another aspect of the present invention, there is provided a display state control program which causes the calculation unit to function as the display state controller according to the above-mentioned another aspect.

According to another aspect of the present invention, there is provided a recording medium recorded with a display state control program according to the above-mentioned another aspect in a manner readable by a calculation unit.

### BRIEF DESCRIPTION OF THE DRAWINGS

In the accompanying drawings:

FIG. 1 is a schematic diagram for explaining problems inherent in conventional techniques of preventing burn-in of a display;

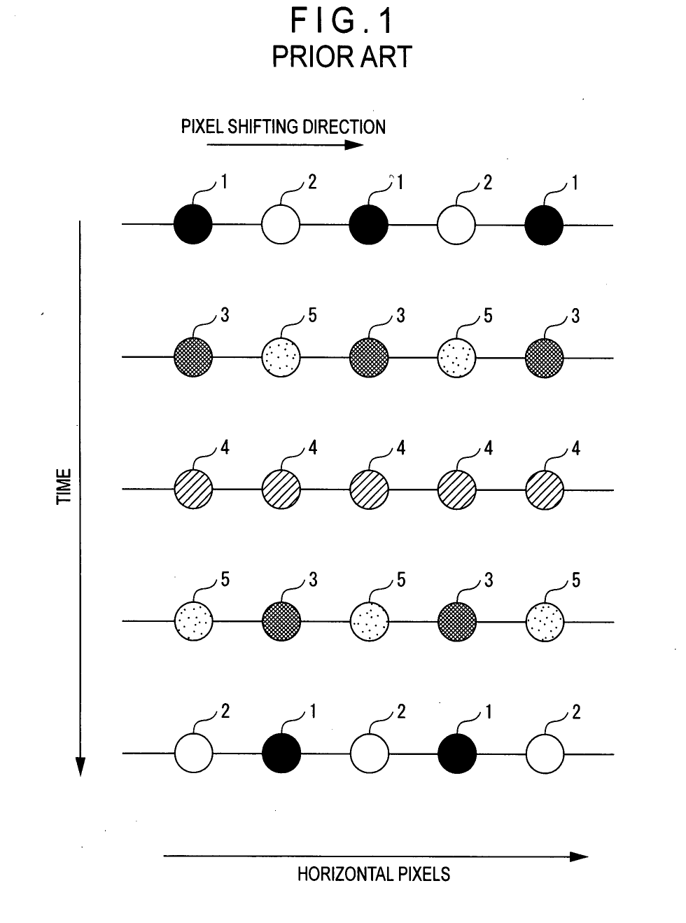

FIG. 2 is a block diagram showing a schematic structure of a display device according to an embodiment of the present invention;

FIG. 3 is a schematic diagram for explaining a control for shifting an image according to the embodiment, in which a state (A) indicates a state of a predetermined region at the same magnification; a state (B), a state where a predetermined region is enlarged rightward by as much as 0.25 pixels from the state (A); a state (C), a state where the predetermined region is enlarged rightward by as much as 0.5 pixels from the state (A); a state (D), a state where the predetermined region is enlarged rightward by as much as 0.75 pixels from the state (A); a state (E), a state where the predetermined region is enlarged rightward by as much as 1 pixel from the state (A); a state (F), a state where the predetermined region is reduced rightward by as much as 0.25 pixels from the state (E); a state (G), a state where the predetermined region is reduced rightward by as much as 0.5 pixels from the state (E); a state (H), a state where the predetermined region is reduced rightward by as much as 0.75 pixels from the state (E); and a state (I), a state where the predetermined region is shifted rightward by as much as 1 pixel from the state (A);

FIG. 4 is a diagram showing, in a table form, an adjustment state of a signal output level in each pixel obtained when the image according to the embodiment is enlarged by as much as predetermined pixels;

FIG. 5 is a flowchart showing display state control processing according to the embodiment;

FIG. 6 is a schematic diagram for explaining a control for shifting an image according to another embodiment of the present invention, in which a state (A) indicates a state of a predetermined region at the same magnification; a state (B), a state where a first region is enlarged rightward by as much as 0.25 pixels from the state (A) and a second region is enlarged rightward by as much as 0.5 pixels from the state (A); a state (C), a state where the first region is enlarged rightward by as much as 1 pixel from the state (A) and the second region is enlarged rightward by as much as 0.25 pixels from the state (A); a state (D), a state where the first region is enlarged rightward by as much as 1 pixel from the state (A), the second region is enlarged rightward by as much as 0.75 pixels from the state (A), and a third region is enlarged rightward by as much as 0.5 pixels from the state (A); and a state (E), a state where each predetermined region is enlarged rightward by as much as 1 pixel from the state (A);

FIG. 7 is a schematic diagram for explaining a control for shifting an image according to the another embodiment of the present invention, in which a state (F) indicates a state where the first region is reduced rightward by as much as 0.5 pixels from the state (E) of FIG. 6 and the second region is reduced rightward by as much as 0.25 pixels from the state (E); a state (G), a state where the first region is reduced rightward by as much as 1 pixel from the state (E) of FIG. 6 and the second region is reduced rightward by as much as 0.5 pixels from the state (E); a state (H), a state where the first region is reduced rightward by as much as 1 pixel from the state (E) of FIG. 6, the second region is reduced rightward by as much as 0.75 pixels from the state (E), and the third region is reduced rightward by as much as 0.5 pixels from the state (E); and a state (I), a state where each predetermined region is shifted rightward by as much as 1 pixel from the state (A) of FIG. 6;

FIG. 8 is a schematic diagram for explaining a control for shifting an image according to another embodiment of the present invention, in which a state (A) indicates a state of a predetermined region at the same magnification; a state (B), a state where the first region is enlarged rightward by as much as 0.5 pixels from the state (A); a state (C), a state where the first region is enlarged rightward by as much as 1 pixel from the state (A) and the second region is enlarged rightward by as much as 0.5 pixels from the state (A); a state (D), a state where the first region is reduced rightward by as much as 0.5 pixels from the state (C), the second region is enlarged rightward by as much as 1 pixel from the state (A), and the third region is enlarged rightward by as much as 0.5 pixels from the state (A); and a state (E), a state where the first region is reduced rightward by as much as 1 pixel from the state (C), the second region is reduced rightward by as much as 0.5 pixels from the state (D), and the third region is enlarged rightward by as much as 1 pixel from the state (A);

FIG. 9 is a schematic diagram for explaining a control for shifting an image according to the another embodiment of the present invention, in which a state (F) indicates a state where the first region is reduced rightward by as much as 1 pixel from the state (C) of FIG. 8, the second region is reduced rightward by as much as 1 pixel from the state (D) of FIG. 8, and the third region is reduced rightward by as much as 0.5 pixels from the state (E) of FIG. 8; and a state (G) indicates a state where each predetermined region is shifted rightward by as much as 1 pixel from the state (A) of FIG. 8; and

FIG. 10 is a schematic diagram for explaining a control for shifting an image according to another embodiment of the present invention, in which a state (A) indicates a state of a predetermined region at the same magnification; a state (B), a state of shifting from the state (A) to a non-shifting enlarged/reduced state; a state (C), a state where an aggregate region is shifted rightward by as much as Q pixels from the state (A); a state (D), a state of shifting from the state (C) to the non-shifting enlarged/reduced state; a state (E), a state where the aggregate region is shifted rightward by as much as (2×Q) pixels from the state (A); a state (F), a state of shifting from the state (E) to the non-shifting enlarged/reduced state; a state (G), a state where the aggregate region is shifted rightward by as much as (3×Q) pixels from the state (A); a state (H), a state of shifting from the state (G) to the non-shifting enlarged/reduced state; and a state (I), a state where the aggregate region is shifted rightward by as much as (4×Q) pixels from the state (A).

### DETAILED DESCRIPTION OF PREFERRED EMBODIMENT(S)

Hereinafter, an embodiment of the present invention will be described with reference to the drawings.

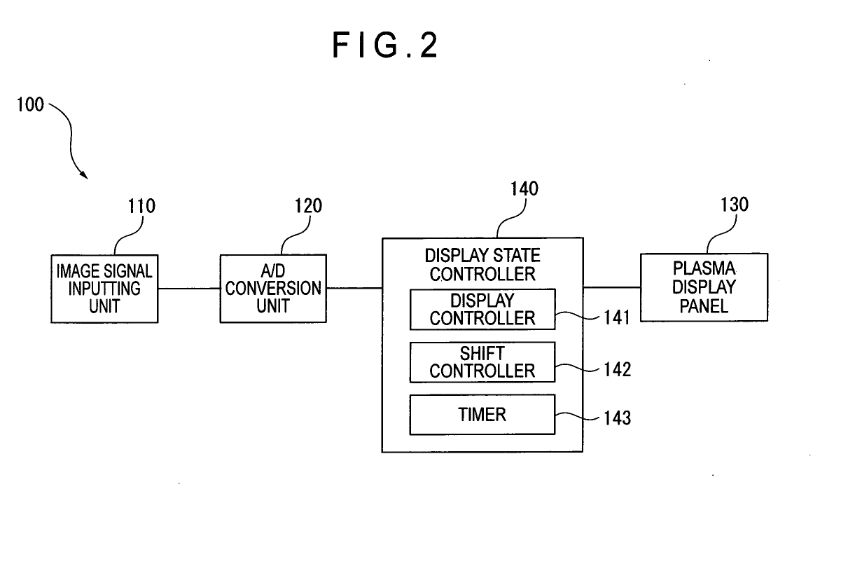

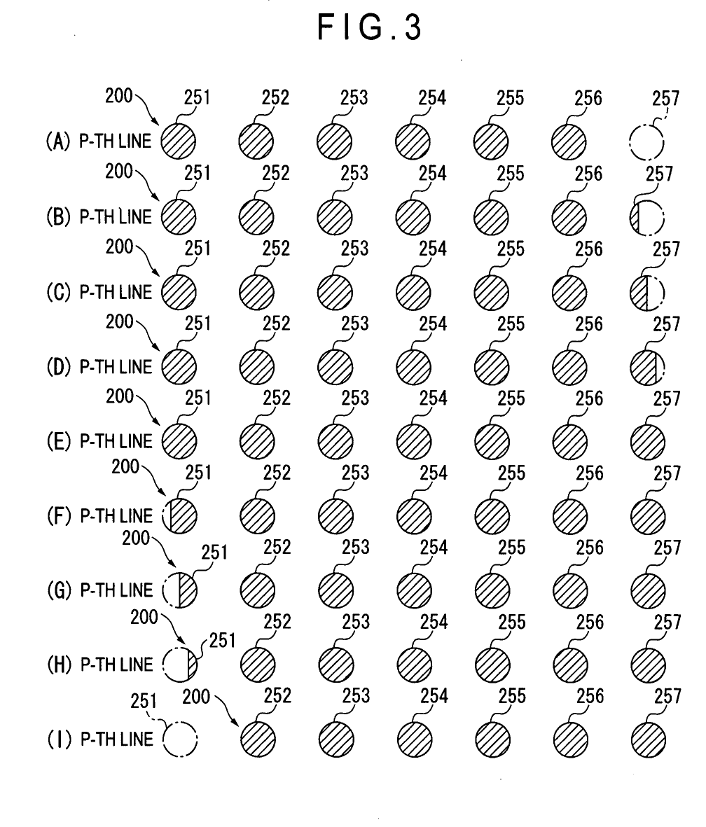

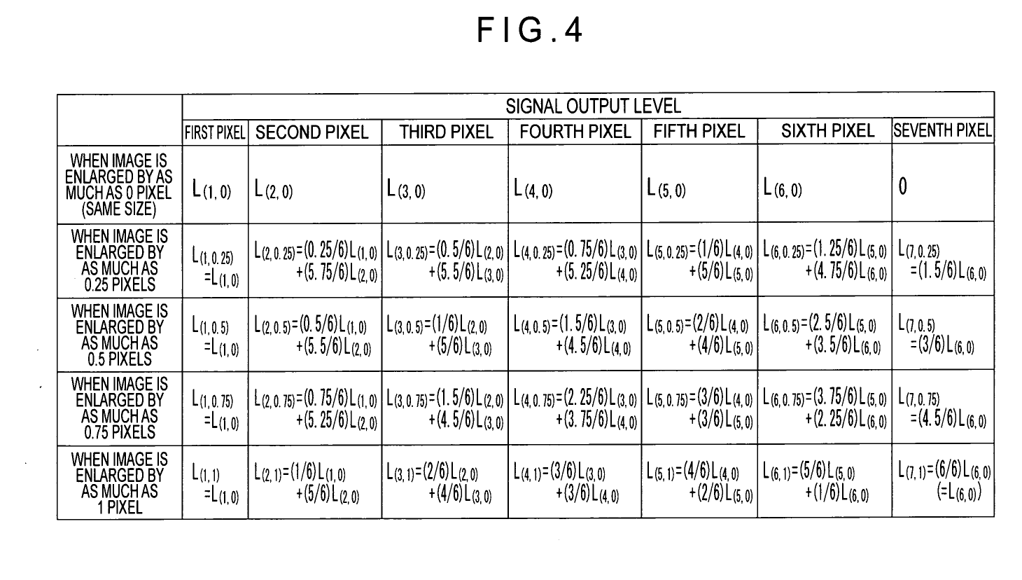

FIG. 2 is a block diagram showing a schematic structure of a display device according to the embodiment of the present invention. FIG. 3 is a schematic diagram for explaining a control for shifting an image. In FIG. 3, a state (A) indicates a state of a predetermined region at the same magnification; a state (B), a state where a predetermined region is enlarged rightward by as much as 0.25 pixels from the state (A); a state (C), a state where the predetermined region is enlarged rightward by as much as 0.5 pixels from the state (A); a state (D), a state where the predetermined region is enlarged rightward by as much as 0.75 pixels from the state (A); a state (E), a state where the predetermined region is enlarged rightward by as much as 1 pixel from the state (A); a state (F), a state where the predetermined region is reduced rightward by as much as 0.25 pixels from the state (E); a state (G), a state where the predetermined region is reduced rightward by as much as 0.5 pixels from the state (E); a state (H), a state where the predetermined region is reduced rightward by as much as 0.75 pixels from the state (E); and a state (I), a state where the predetermined region is shifted rightward by as much as 1 pixel from the state (A). FIG. 4 is a diagram showing, in a table form, an adjustment state of a signal output level in each pixel when the image is enlarged by as much as the predetermined pixels.

### (Structure of Display Device)

In FIG. 2, reference numeral 100 denotes a display device. The display device 100 includes an image signal inputting unit 110, an A/D conversion unit 120, a plasma display panel 130 serving as a display unit, and a display state controller 140.

The image signal inputting unit 110 receives input of an image signal having a component signal and an RGB signal, executes processing such as input switching, color separation, and color demodulation, and outputs the signal to the A/D conversion unit 120.

The A/D conversion unit 120 converts various signals inputted from the image signal inputting unit 110 into digital signals, and then outputs the digital signals to the display state controller 140.

The plasma display panel 130 displays a predetermined image based on a control of the display state controller 140.

The plasma display panel 130 includes a plurality of pixels arranged in vertical and horizontal directions.

The display state controller 140 controls the plasma display panel 130 to display a predetermined image in response to the digital signals from the A/D conversion unit 120.

The display state controller 140 includes a display controller 141, a shift controller 142, and a timer 143.

The timer 143 counts time based on a reference pulse such as an internal clock, and appropriately outputs clock information regarding the counted time.

The display controller 141 acquires a digital signal from the A/D conversion unit 120, and then lights each pixel at a signal output level corresponding to the digital signal, thereby controlling the plasma display panel 130 to display the predetermined image.

The shift controller 142 controls a lighting state of each pixel, and enlarges or reduces all the regions of the image displayed on the display controller 141 at the same timing by a small length dimension in a horizontal direction, thereby shifting the regions by a small distance.

The control of the shift controller 142 will be herein described with reference to the states (A) to (I) of FIG. 3, and FIG. 4.

In order to facilitate understanding of the contents of the control, a description is given by illustrating a structure for displaying a predetermined region of an image by appropriately using seven pixels constituting a P-th (P is a natural number) line of the display region, and by illustrating a case where a still image is displayed.

Further, in the states (A) to (I) of FIG. 3, hatching shown in circles each representing the first to seventh pixels 251 to 257 indicates a predetermined region 200 of an image. For example, the state (A) of FIG. 3 shows that the magnitude of the predetermined region 200 corresponds to six pixels, that is, the first to sixth pixels 251 to 256 put together. Further, the states (B), (C), (D), and (E) of FIG. 3 show that the magnitude of the predetermined region 200 corresponds to 6.25 pixels, 6.5 pixels, 6.75 pixels, and 7 pixels, respectively.

The shift controller 142 performs the following processing as processing of enlarging the predetermined region 200.

That is, assuming that the number of pixels displaying the predetermined region 200 in a state where the predetermined region 200 is neither enlarged nor reduced, that is, at the same magnitude, is represented by H, a value obtained by diving the magnitude of the predetermined region 200 to be enlarged by the magnitude of 1 pixel is represented by J, a signal output level in an enlargement reference pixel obtained before the predetermined region 200 is enlarged is represented by L (1, 0), and a signal output level in a pixel which is K (K is a natural number of 1 or larger) pixels next to the enlargement reference pixel obtained before the predetermined region 200 is enlarged is represented by L (K+1, 0), the signal output level in the enlargement reference pixel is controlled to be in a state of L (1, J) obtained by the following formula (1).

L(1, J)=L(1, 0) (1)

Further, the signal output level in the pixel which is K pixels next to the enlargement reference pixel is controlled to be in a state of L (K+1, J) obtained by the following formula (2).

L(K+1, J)=((K×J)/H)×L(K, 0)+((H−K×J)/H×L(K+1, 0) (2)

Specifically, the shift controller 142 performs control, through the control of the display controller 141, such that the image is displayed without being enlarged nor reduced, and as shown in the state (A) of FIG. 3, the magnitude of the predetermined region 200 displayed by the P-th line is the same size as the six pixels. In other words, as shown in FIG. 4, the signal output levels in the first pixel 251, the second pixel 252, the third pixel 253, the fourth pixel 254, the fifth pixel 255, the sixth pixel 256, and the seventh pixel 257 that are in the same size are represented by L(1, 0), L(2, 0), L(3, 0), L(4, 0), L(5, 0), L(6, 0), and 0, respectively.

In this case, the value H in the formulae (1) and (2) is 6. The values J corresponding to the third pixel 253, the fourth pixel 254, the fifth pixel 255, the sixth pixel 256, and the seventh pixel 257 are 1, 2, 3, 4, and 5, respectively. Further, the values K corresponding to the second pixel 252, the third pixel 253, the fourth pixel 254, the fifth pixel 255, the sixth pixel 256, and the seventh pixel 257 are 1, 2, 3, 4, 5, and 6, respectively.

The shift controller 142 enlarges the predetermined region 200 by as much as 0.25 pixels rightward with the first pixel 251 as a reference from state of the region in the same size as shown in the state (A) of FIG. 3, that is, controls the lighting state of the first to seventh pixels 251 to 257 to be in a state where the magnitude of the predetermined region 200 corresponds to 6.25 pixels as shown in the state (B) of FIG. 3.

In this case, the value J in the formulae (1) and (2) is 0.25.

For this reason, as shown in FIG. 4, the shift controller 142 controls the signal output level L(1, 0.25) of the first pixel 251, which is the enlargement reference pixel, to be in a state of L(1, 0) based on the formula (1). Specifically, the shift controller 142 controls the signal output level of the first pixel 251 not to be changed.

Further, the signal output level L(2, 0.25) of the second pixel 252 when the value K in the formula (2) is, for example, 1, that is, a pixel one pixel next to the first pixel 251 is controlled to be in a state of (0.25/6)L(1, 0)+(5.75/6)L(2, 0) based on the formula (2).

Then, the signal output level L(7, 0.25) of the seventh pixel 257 when the value K in the formula (2) is 6 is controlled to be in a state of (1.5/6)L(6, 0) based on the formula (2).

Further, the shift controller 142 enlarges the predetermined region 200 by as much as 0.25 pixels rightward with the first pixel 251 as a reference from the state as shown in the state (B) of FIG. 3, that is, enlarges the predetermined region 200 by as much as 0.5 pixels from the state of the region in the same size to thereby control the magnitude of the predetermined region 200 to correspond to 6.5 pixels as shown in the state (C) of FIG. 3.

In this case, the value J in the formulae (1) and (2) is 0.5.

For this reason, the shift controller 142 controls the respective signal output levels L(1, 0.5), L(2, 0.5), L(3, 0.5), L(4, 0.5), L(5, 0.5), L(6, 0.5), and L(7, 0.5) of the first to seventh pixels 251 to 257 to be in the state as shown in FIG. 4.

Further, the shift controller 142 enlarges the predetermined region 200 by as much as 0.25 pixels rightward with the first pixel 251 as a reference from the state as shown in the state (C) of FIG. 3, that is, enlarges the predetermined region 200 by as much as 0.75 pixels from the state of the region in the same size to thereby control the magnitude of the predetermined region 200 to correspond to 6.75 pixels as shown in the state (D) of FIG. 3.

In this case, the value J in the formulae (1) and (2) is 0.75.

For this reason, the shift controller 142 controls the respective signal output levels L(1, 0.75), L(2, 0.75), L(3, 0.75), L(4, 0.75), L(5, 0.75), L(6, 0.75), and L(7, 0.75) of the first to seventh pixels 251 to 257 to be in the state as shown in FIG. 4.

Further, the shift controller 142 enlarges the predetermined region 200 by as much as 0.25 pixels rightward with the first pixel 251 as a reference from the state as shown in the state (D) of FIG. 3, that is, enlarges the predetermined region 200 by as much as 1 pixel from the state of the region in the same size to thereby control the magnitude of the predetermined region 200 to correspond to 7 pixels as shown in the state (E) of FIG. 3.

In this case, the value J in the formulae (1) and (2) is 1.

For this reason, the shift controller 142 controls the respective signal output levels L(1, 1), L(2, 1), L(3, 1), L(4, 1), L(5, 1), L(6, 1), and L(7, 1) of the first to seventh pixels 251 to 257 to be in the state as shown in FIG. 4.

Then, after performing the control to enlarge the predetermined region 200 by as much as 1 pixel from the state of the region in the same size, the shift controller 142 controls the signal output levels of the first pixel 251 to the seventh pixel 257 to become values obtained based on a formula substantially corresponding to the formulae (1) and (2), thereby controlling the predetermined region 200 to be reduced by as much as 1 pixel with the seventh pixel 257 as a reference.

Specifically, the shift controller 142 reduces the predetermined region 200 by as much as 0.25 pixels rightward with the seventh pixel 257 as a reference from the state as shown in the state (E) of FIG. 3, that is, controls the predetermined region 200 to be in a state where the magnitude of the predetermined region 200 corresponds to 6.75 pixels as shown in the state (F) of FIG. 3.

Further, the shift controller 142 performs twice the control for reducing the predetermined region 200 by as much as 0.25 pixels rightward with the seventh pixel 257 as a reference from the state as shown in the state (F) of FIG. 3. In other words, as shown in the states (G) and (H) of FIG. 3, the shift controller 142 controls the predetermined region 200 to be in a state where the magnitude of the predetermined region 200 corresponds to 6.5 pixels and 6.25 pixels, respectively.

Then, the shift controller 142 reduces the predetermined region 200 by as much as 0.25 pixels rightward with the seventh pixel 257 as a reference from the state as shown in the state (H) of FIG. 3, that is, controls the predetermined region 200 to be in a state where the magnitude of the predetermined region 200 corresponds to 6 pixels as shown in the state (I) of FIG. 3.

Through the controls, the predetermined region 200 is shifted by as much as 1 pixel rightward from the state of the region in the same size.

The shift controller 142 executes the above-mentioned controls at the same timing with respect to the entire region of the image displayed on the plasma display panel 130, thereby performing a control for shifting the entire image by as much as 1 pixel rightward. Then, the shift controller 142 executes the above-mentioned controls with respect to the entire region of the image in a reverse order, thereby performing a control for shifting the entire image by as much as 1 pixel leftward. In other words, the shift controller 142 performs a control such that the state as shown in the state (I) of FIG. 3 is returned to the state as shown in the state (A) of FIG. 3.

### (Operation of Display Apparatus)

Next, the operation of the display device 100 will be described with reference to the drawings.

In order to facilitate understanding of the contents of the operation, a description is given by illustrating a structure for displaying an image by controlling lighting states of seven pixels constituting the P-th line of the display region, in the same manner as in the states (A) to (I) of FIG. 3 and FIG. 4.

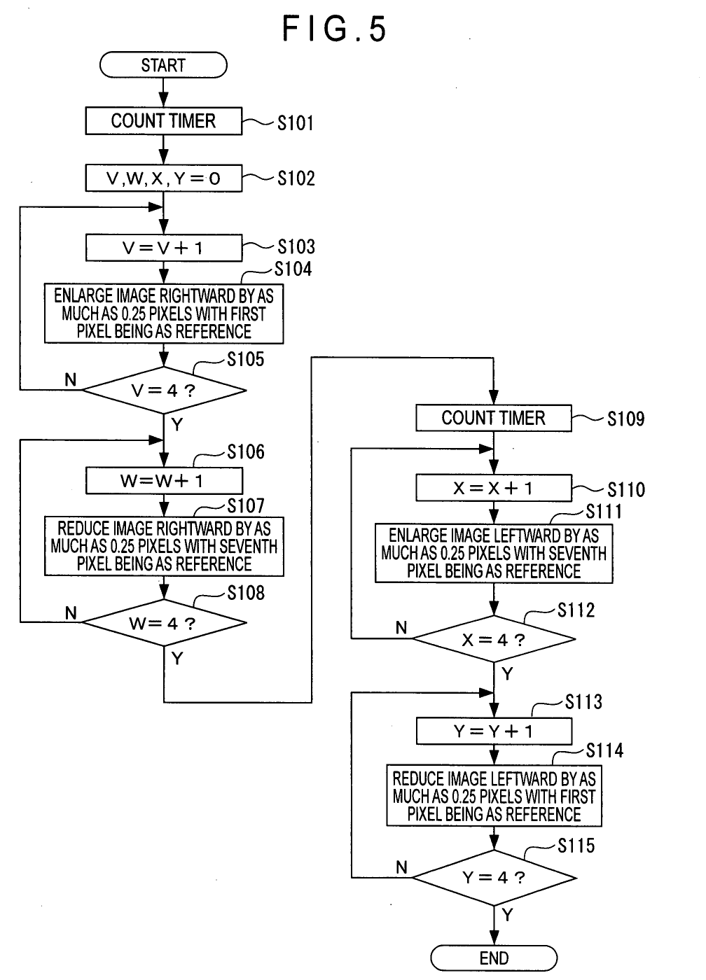

FIG. 5 is a flowchart showing display state control processing.

The display device 100 displays an image corresponding to an image signal inputted to the image signal inputting unit 110, on the plasma display panel 130 through the control of the display controller 141 of the display state controller 140.

As shown in FIG. 5, the shift controller 142 of the display state controller 140 executes timer count processing based on the clock information obtained from the timer 143 (Step S101), and performs processing of setting variables V, W, X, and Y to 0 (Step S102).

After that, the shift controller 142 performs processing of adding 1 to the variable V (Step S103). Then, the shift controller 142 performs a control for enlarging the predetermined region 200 by as much as 0.25 pixels rightward with the first pixel 251 as a reference (Step S104) and judges whether or not the variable V is 4 (Step S105).

In Step S105, when it is judged that the variable V is not 4, the shift controller 142 executes the processing of Step S103.

On the other hand, in Step S105, when it is judged that the variable V is 4, that is, when it is judged that the shift controller 142 has executed the processing of Step S104 four times and has performed the control for enlarging the predetermined region 200 rightward by as much as 1 pixel with the first pixel 251 as a reference, the shift controller 142 performs processing of adding 1 to the variable W (Step S106). After that, the shift controller 142 performs a control for reducing the predetermined region 200 by as much as 0.25 pixels rightward with the seventh pixel 257 as a reference (Step S107), and judges whether or not the variable W is 4 (Step S108).

Then, in Step S108, when it is judged that the variable W is not 4, the shift controller 142 executes the processing of Step S106.

On the other hand, in Step S108, when it is judged that the variable W is 4, that is, when it is judged that the shift controller 142 has executed the processing of Step S107 four times and has performed the control for reducing the predetermined region 200 by as much as 1 pixel rightward with the first pixel 251 as a reference, the shift controller 142 performs the timer count processing (Step S109), and performs processing of adding 1 to the variable X (Step S110). After that, the shift controller 142 performs a control for enlarging the predetermined region 200 by as much as 0.25 pixels leftward with the seventh pixels 257 as a reference (Step S111), and judges whether or not the variable X is 4 (Step S112).

In Step S112, when it is judged that the variable X is not 4, the shift controller 142 executes the processing of Step S110.

On the other hand, in Step S112, when it is judged that the variable X is 4, that is, when it is judged that the shift controller 142 has executed the processing of Step S111 four times and has performed the control for enlarging the predetermined region 200 leftward by as much as 1 pixel with the seventh pixels 257 as a reference, the shift controller 142 performs processing of adding 1 to the variable Y (Step S113). After that, the shift controller 142 performs a control for reducing the predetermined region 200 by as much as 0.25 pixels rightward with the first pixels 251 as a reference (Step S114), and judges whether or not the variable Y is 4 (Step S115).

Then, in Step S115, when it is judged that the variable Y is not 4, the shift controller 142 executes the processing of Step S113.

On the other hand, in Step S113, when it is judged that the variable Y is 4, that is, when it is judged that the shift controller 142 has executed the processing of Step S114 four times and has performed the control for reducing the predetermined region 200 by as much as 1 pixel leftward with the first pixel 251 as a reference, in other words, when it is judged that the predetermined region 200 has returned to the state before the shift control is started, the shift controller 142 finishes the processing.

### (Operations and Effects of Display Device)

As described above, according to the embodiment, the display state controller 140 of the display device 100 executes the processing of enlarging the predetermined region 200 of the image rightward by as much as 0.25 pixels with the first pixel 251 as a reference, and the processing of reducing the predetermined region 200 rightward by as much as 0.25 pixels with the seventh pixel 257 as a reference, thereby performing a control for shifting the predetermined region 200 rightward. Specifically, the display state controller 140 executes the processing of enlarging the predetermined region 200 so that the enlarged amount in one step is smaller than 1 pixel in a state where one end is made apart from the other end when the one end is set as a reference, and the processing of reducing the predetermined region 200 so that the reduced amount in one step is smaller than 1 pixel in a state where one end thereof is made closer to the other end thereof when the one end is set as a reference, thereby performing a control for shifting the predetermined region 200 to the other end side.

Thus, the image is shifted by enlarging or reducing the magnitude of the predetermined region 200 so that the enlarged amount or the reduced amount thereof in each one step is smaller than 1 pixel, thereby making it possible to shift the image while changing the magnitude of the image without giving a visually unnatural impression.

Further, the image is shifted by controlling the lighting state of each pixel, which can also be applied to the processing using digital signals.

Further, it is unnecessary to execute image conversion processing or image display position shifting processing or to use pixel conversion coefficients, thereby making it possible to shift the image with simplified processing.

Further, the image is shifted while changing the magnitude thereof, thereby making it possible to suppress blurring of the entire image as compared with the structure for shifting an image without changing the magnitude of the image.

Therefore, it is possible to prevent burn-in of the plasma display panel 130 appropriately and easily.

Then, the display state controller 140 executes the processing of enlarging the predetermined region 200 leftward by as much as 0.25 pixels with the seventh pixel 257 as a reference, and the processing of reducing the predetermined region 200 leftward by as much as 0.25 pixels with the first pixel 251 as a reference, thereby performing a control for shifting the predetermined region 200 leftward.

Thus, it is possible to reciprocatingly shift the image in the horizontal direction even within the limited display region, and the number of times of shifting the image is not limited. On the other hand, in the structure in which the image can be shifted only in one direction, the number of times of shifting the image is limited.

Accordingly, the burn-in can be more prevented as compared with the structure in which the image can be shifted only in one direction.

In addition, the display state controller 140 shifts the predetermined region 200 in a state where the magnitude of the region to be enlarged and the magnitude of the region to be reduced are the same.

As a result, it is possible to perform the control in enlarging and reducing the predetermined region 200 more easily as compared with the structure for shifting the predetermine region 200 in a state where the magnitude of the region to be enlarged and the magnitude of the region to be reduced are different from each other.

Further, it is possible to make the change ratio of the magnitude constant, and suppress the visually unnatural impression.

Then, the display state controller 140 executes the processing of enlarging the predetermined region 200 and the processing of reducing the predetermined region 200 at the same timing with respect to the entire region of the image.

For this reason, it is possible to perform the control in enlarging or reducing the predetermined region 200 more easily as compared with a structure for enlarging or reducing the predetermined region at different timings for each region.

In addition, it is possible to enlarge or reduce the entire image at the same timing and in the same magnitude, and further prevent giving of the visually unnatural impression.

The display state controller 140 executes processing of controlling the signal output levels of the first to seventh pixels 251 to 257 to become values obtained based on the formulae (1) and (2) as the processing of enlarging the predetermined region 200.

Thus, the predetermined region 200 can be enlarged through simple processing of only substituting values corresponding to the first to seventh pixels 251 to 257 to the formulae (1) and (2), thereby making it possible to swiftly perform processing of shifting the image.

The display state controller 140 is provided to the display device 100.

Thus, it is possible to provide the display device 100 capable of preventing the burn-in of the plasma display panel 130 appropriately and easily.

Further, it is possible to extend a lifetime of the plasma display panel 130.

### Modification of Embodiment

The present invention is not limited to the above-mentioned embodiment, but includes modifications described below within the gist of the present invention.

In other words, it is possible to employ a structure for shifting the predetermined region 200 only rightward or leftward without reciprocatingly shifting the predetermined region 200 in the horizontal direction.

With the structure, the control for shifting the predetermined region 200 can be easily performed.

Alternatively, it is possible to employ a structure for shifting the predetermined region 200 in a state where the magnitude of the region to be enlarged and the magnitude of the region to be reduced are different from each other. For example, after the processing of enlarging the predetermined region 200 rightward by as much as 0.25 pixels is successively performed twice, the processing of reducing the predetermined region 200 rightward by as much as 0.5 pixels may be performed once, to thereby shift the predetermined region 200 rightward by as much as 0.5 pixels.

Further, it is possible to employ a structure for shifting the predetermined region 200 in a vertical direction or a structure for shifting the predetermined region 200 in the vertical and horizontal directions.

The magnitude of the region to be enlarged or reduced is not limited to 0.25 pixels, any magnitude such as 0.1 pixels or 0.8 pixels may be adopted as long as the enlarged amount or the reduced amount in one step is less than 1 pixel.

When the processing of enlarging the predetermined region 200 is executed, it is possible to employ a structure in which the control of the signal output level based on the formulae (1) and (2) is not executed.

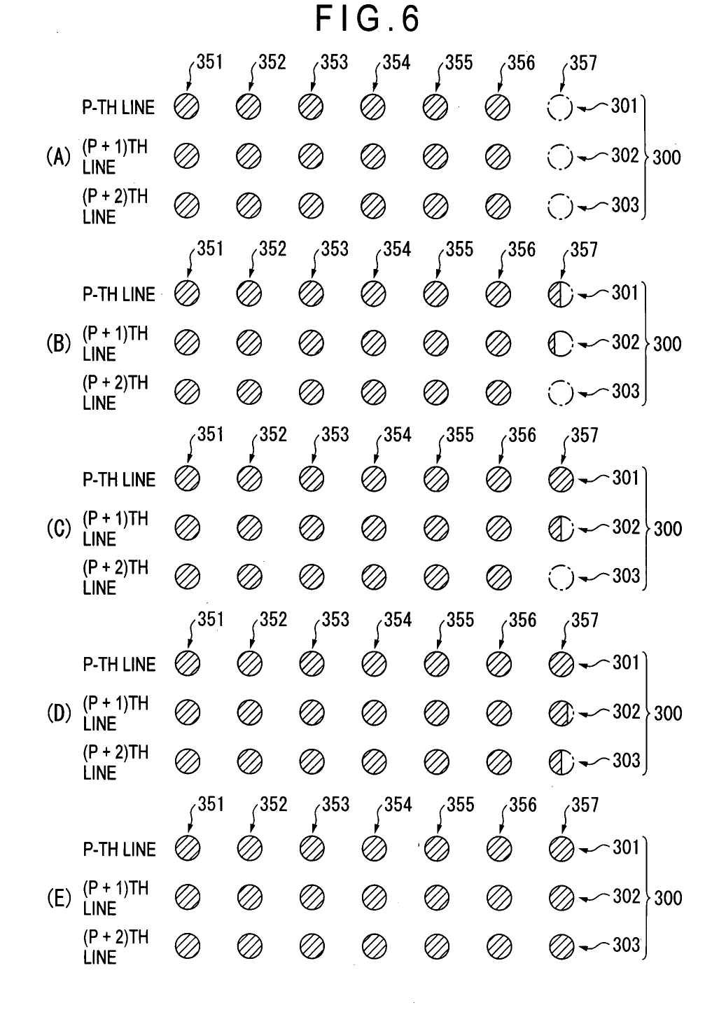

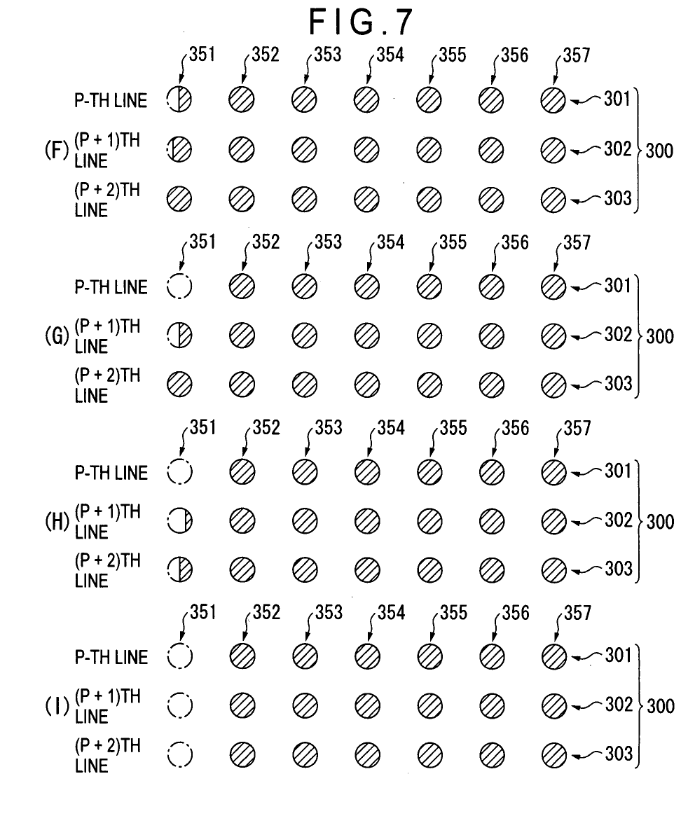

Alternatively, it is possible to employ a structure for executing the controls as shown in the states (A) to (E) of FIG. 6 and the states (F) to (I) of FIG. 7.

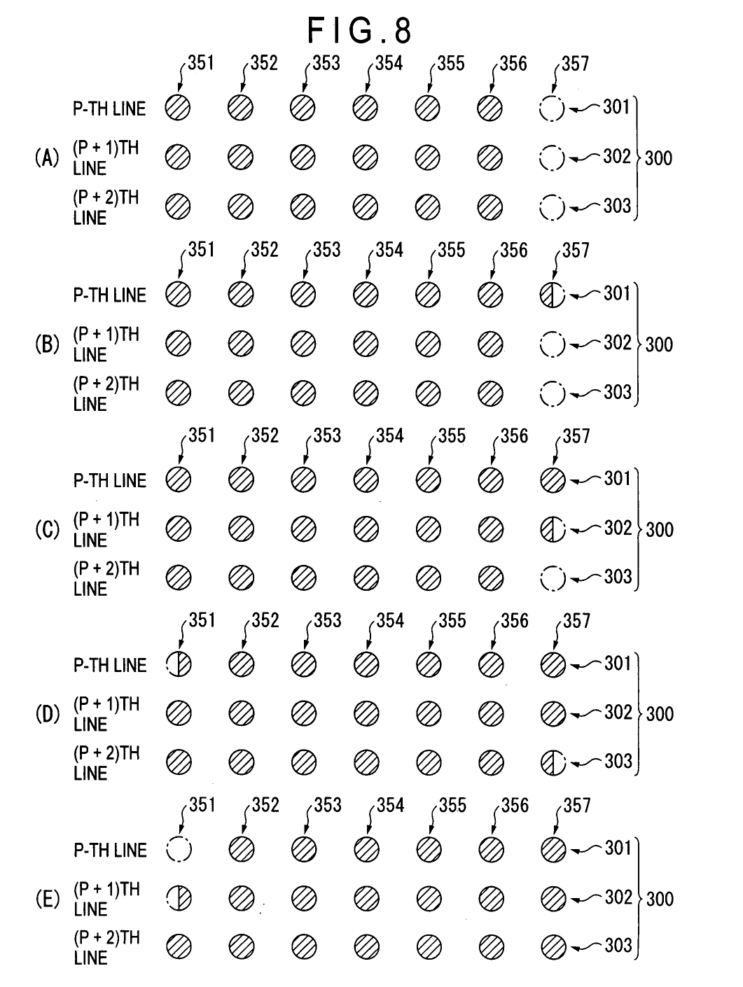

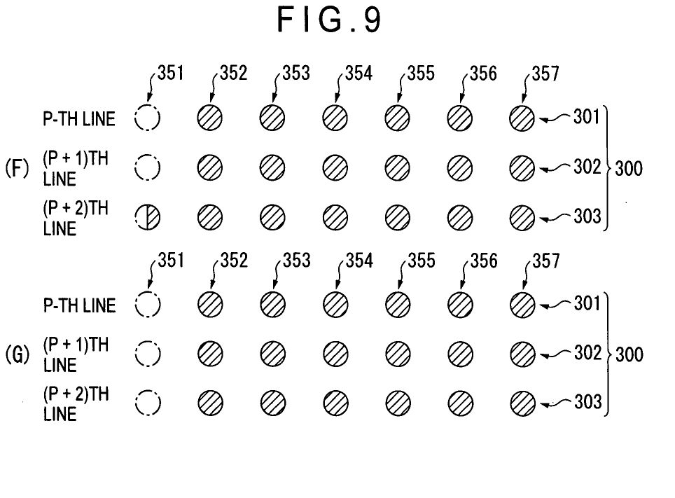

In the states (A) to (E) of FIG. 6 and the states (F) to (I) of FIG. 7, and in the below-mentioned states (A) to (E) of FIG. 8 and states (F) and (G) of FIG. 9, hatching shown in the circles representing a first pixel 351, a second pixel 352, a third pixel 353, a fourth pixel 354, a fifth pixel 355, a sixth pixel 356, and a seventh pixel 357, respectively, indicates a predetermined region 300 of an image.

Specifically, as shown in the state (A) of FIG. 6, the predetermined region 300 having the magnitude in the horizontal direction corresponding to 6 pixels is displayed by using the first to seventh pixels 351 to 357 constituting the P-th line, the (P+1)th line, the (P+2)th line.

Further, processing of enlarging a first region 301 corresponding to the P-th line rightward by as much as 0.5 pixels with the first pixel 351 as a reference from the state of the region in the same size shown in the state (A) of FIG. 6, and enlarging a second region 302 corresponding to the (P+1)th line rightward by as much as 0.25 pixels is performed twice, thereby making each magnitude of the first region 301 in the states (B) and (C) of FIG. 6 correspond to 6.5 pixels and 7 pixels, and making each magnitude of the second region 302 in the states (B) and (C) correspond to 6.25 pixels and 6.5 pixels, respectively.

After that, processing of enlarging the second region 302 rightward by as much as 0.25 pixels and enlarging a third region 303 corresponding to the (P+2)th line rightward by as much as 0.5 pixels with the first pixel 351 as a reference is performed twice, thereby making each magnitude of the second region 302 in the states (D) and (E) of FIG. 6 correspond to 6.75 pixels and 7 pixels, and making each magnitude of the third region 303 in the states (D) and (E) correspond to 6.5 pixels and 7 pixels, respectively.

Through the controls, each magnitude of the first to third regions 301 to 303 corresponds to 7 pixels. That is, the predetermined region 300 is enlarged rightward by as much as 1 pixel.

Further, processing of reducing the first region 301 rightward by as much as 0.5 pixels with the seventh pixel 357 as a reference and reducing the second region 302 rightward by as much as 0.25 pixels is performed twice. After that, processing of reducing the second region 302 rightward by as much as 0.25 pixels and reducing the third region 303 rightward as much as 0.5 pixels with the seventh pixel 357 as a reference is performed twice.

Specifically, each magnitude of the first region 301 in the states (F) to (I) of FIG. 7 is made to correspond to 6.5 pixels, 6 pixels, 6 pixels, and 6 pixels, each magnitude of the second region 302 in the states (F) to (I) is made to correspond to 6.75 pixels, 6.5 pixels, 6.25 pixels, and 6 pixels, and each magnitude of the third region 303 in the states (F) to (I) is made to correspond to 7 pixels, 7 pixels, 6.5 pixels, and 6 pixels, respectively.

Through the controls, the predetermined region 300 is shifted rightward by as much as 1 pixel.

Alternatively, it is possible to employ a structure for executing the control as shown in the states (A) to (E) of FIG. 8, and the states (F) and (G) of FIG. 9.

Specifically, after the predetermined region 300 as shown in the state (A) of FIG. 8 is displayed, the first region 301 is enlarged rightward by as much as 0.5 pixels with the first pixel 351 as a reference, and as shown in the state (B) of FIG. 8, the magnitude of the first region 301 is made to correspond to 6.5 pixels.

After that, the first region 301 is enlarged rightward by as much as 0.5 pixels and the second region 302 is enlarged rightward by as much as 0.5 pixels with the first pixel 351 as a reference, and then the magnitudes of the first region 301 and the second region 302 are made to respectively correspond to 7 pixels and 6.5 pixels as shown in the state (C) of FIG. 8.

Then, the first region 301 is reduced rightward by as much as 0.5 pixels with the seventh pixel 357 as a reference and the second region 302 and the third region 303 are respectively enlarged rightward by as much as 0.5 pixels, and then the magnitudes of the first to third regions 301 to 303 are made to respectively correspond to 6.5 pixels, 7 pixels, and 6.5 pixels as shown in the state (D) of FIG. 8.

After that, the first region 301 and the second region 302 are respectively reduced rightward by as much as 0.5 pixels with the seventh pixel 357 as a reference and the third region 303 is enlarged rightward by as much as 0.5 pixels, and then the magnitudes of the first to third regions 301 to 303 are made to respectively correspond to 6 pixels, 6.5 pixels, and 7 pixels as shown in the state (E) of FIG. 8.

Further, the second region 302 and the third region 303 are respectively reduced rightward by as much as 0.5 pixels with the seventh pixel 357 as a reference, and then only the third region 303 is reduced rightward by as much as 0.5 pixels.

Specifically, each magnitude of the second region 302 in the states (F) and (G) of FIG. 8 is made correspond to 6 pixels and 6 pixels, and each magnitude of the third region 303 in the states (F) and (G) is made correspond to 6.5 pixels and 6 pixels.

Through the controls, the predetermined region 300 is shifted rightward by as much as 1 pixel.

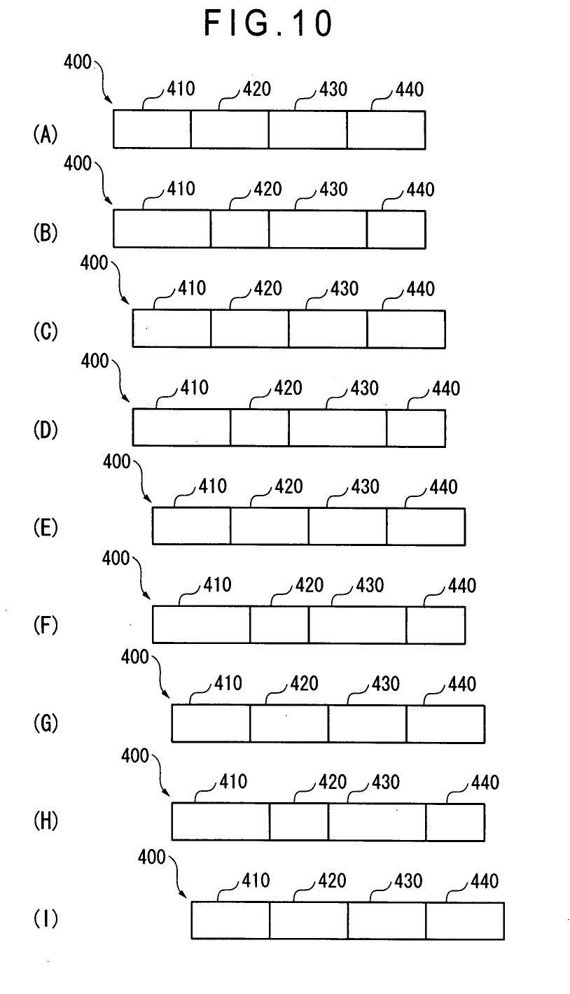

Alternatively, it is possible to employ a structure for executing the control as shown in the states (A) to (I) of FIG. 10.

Specifically, as shown in the state (A) of FIG. 10, an aggregate region 400 constituting a first predetermined region 410, a second predetermined region 430, a third predetermined region 430, and a fourth predetermined region 440 that are adjacent to each other in the horizontal direction is displayed.

Then, as shown in the state (B) of FIG. 10, the first predetermined region 410 and the third predetermined region 430 are enlarged rightward with left ends of the first and third predetermined regions 410 and 430 as a reference, and the second predetermined region 420 and the fourth predetermined region 440 are reduced rightward with right ends of the second and fourth predetermined regions 420 and 440 as a reference (hereinafter, referred to as “first enlarging/reducing processing”). In this case, each magnitude of the enlarged or reduced first to fourth predetermined regions 410 to 440 is the same, and the magnitude thereof corresponds to Q (0<Q<1) pixels which is smaller than the magnitude of the pixels.

Thus, while the magnitudes of the first to fourth predetermined regions 410 to 440 are changed, the aggregate region 400 is not shifted (hereinafter, referred to as “non-shifting enlarged/reduced state”).

After that, as shown in the state (C) of FIG. 10, the first and third predetermined regions 410 and 430 are reduced rightward with the right ends thereof as a reference, and the second and fourth predetermined regions 420 and 440 are enlarged rightward with the left ends thereof as a reference (hereinafter, referred to as “second enlarging/reducing processing”). As a result, the aggregate region 400 is shifted rightward by as much as Q pixels (hereinafter, referred to as “rightward shifted state”).

Further, the first enlarging/reducing processing and the second enlarging/reducing processing are alternately performed three times each.

Thus, as shown in the states (D) to (I) of FIG. 10, the non-shifting enlarged/reduced state and the rightward shifted state are alternately obtained, and the aggregate region 400 is shifted rightward by as much as (4×Q) pixels from the state as shown in the state (A) of FIG. 10.

In the structure, the first to fourth predetermined regions 410 to 440 are enlarged or reduced at different timing, which complicates the control thereof as compared with the structure according to the embodiment, while it is possible to prevent the burn-in of the display more appropriately and easily as compared with the conventional structure.

In the structures shown in FIGS. 6 to 10, a control for the signal output levels based on the formulae (1) and (2) may be executed.

It is possible to employ a structure in which the shift controller 142 may be provided separately from the display device 100 so that the shift controller 142 can be appropriately connected to the display device 100.

Further, the display state controller according to the present invention may be applied to a display device including a liquid crystal panel serving as a display unit, an organic electro luminescence (EL) panel, a CRT, and a field emission display (FED).

The above-mentioned functions are implemented as a program, but may be implemented by, for example, hardware such as a circuit board or a device such as an integrated circuit (IC), and thus the functions can be implemented in any forms. By providing a structure for reading the functions from a program or a separate recording medium by using a computer serving as a calculation unit, it is possible to deal with the functions more easily and enlarge the utilization thereof more easily.

Other details such as a specific structure or procedure in carrying out the present invention may be appropriately changed to other structures within the gist of the present invention.

### Operations and Effects of Embodiment

As described above, according to the embodiment, the display state controller 140 of the display device 100 executes the processing of enlarging the predetermined region 200 of the image rightward by as much as 0.25 pixels with the first pixel 251 as a reference, and the processing of reducing the predetermined region 200 rightward by as much as 0.25 pixels with the seventh pixel 257 as a reference, thereby performing the control for shifting the predetermined region 200 rightward.

Thus, the image is shifted by enlarging or reducing the magnitude of the predetermined region 300 so that the enlarged amount or the reduced amount in one step is smaller than 1 pixel, thereby making it possible to shift the image while changing the magnitude of the image without giving a visually unnatural impression.

Further, the image is shifted by controlling the lighting state of each pixel, which can also be applied to the processing using digital signals.

In addition, it is unnecessary to execute image conversion processing or image display position shifting processing or to use pixel conversion coefficients, thereby making it possible to shift the image with simplified processing.

Further, the image is shifted while changing the magnitude thereof, which can suppress blurring of the entire image as compared with the structure for shifting an image without changing the magnitude of the image.

Therefore, it is possible to prevent burn-in of the plasma display panel 130 appropriately and easily.

The display state controller 140 is provided to the display device 100.

Accordingly, it is possible to provide the display device 100 capable of preventing the burn-in of the plasma display panel 130 appropriately and easily.

Further, it is possible to extend a lifetime of the plasma display panel 130.

The priority application number JP2006-115729 upon which this patent application is based is hereby incorporated by reference.

What is claimed is:

1. A display state controller for controlling a display state of an image corresponding to an input image signal, the image being displayed on a display unit that has a plurality of pixels, the display state controller comprising:
a shift controller that shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.

2. The display state controller according to claim 1, wherein
the shift controller shifts the predetermined regions to the one ends by performing: processing of enlarging the predetermined regions with the other ends as references so that an enlarged amount in one step is smaller than 1 pixel, in such a manner that the one ends are made apart from the other ends; and processing of reducing the predetermined regions with the one ends as references so that an reduced amount in one step is smaller than 1 pixel, in such a manner that the other ends are made closer to the one ends.

3. The display state controller according to claim 1, wherein
the shift controller shifts the predetermined regions in such a manner that the enlarged amount and the reduced amount are the same.

4. The display state controller according to claim 1, wherein
the shift controller performs at least one of the processing of enlarging the predetermined regions and the processing of reducing the predetermined regions with respect to an entire region of the image at the same timing.

5. A display device, comprising:
a display unit;
a display controller that acquires an input image signal and causes the display unit to display an image corresponding to the input image signal; and
a display state controller that controls a display state of an image displayed on the display unit, the display state controller controlling a display state of an image corresponding to an input image signal, the image being displayed on a display unit that has a plurality of pixels, the display state controller comprising:
a shift controller that shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.

6. The display device according to claim 5, wherein
the display unit is a plasma display panel.

7. A display state control method of controlling, by a calculation unit, a display state of an image displayed on a display unit corresponding to an input image signal, wherein
the display unit includes a plurality of pixels, and
the calculation unit shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.

8. A display state control program for causing a calculation unit to execute a display state control method of controlling, by a calculation unit, a display state of an image displayed on a display unit corresponding to an input image signal, wherein
the display unit includes a plurality of pixels, and
the calculation unit shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.

9. A display state control program for causing a calculation unit to function as a display state controller for controlling a display state of an image corresponding to an input image signal, the image being displayed on a display unit that has a plurality of pixels, the display state controller comprising:
a shift controller that shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.

10. A recording medium recorded with a display state control program in a manner readable by a calculation unit, the display state control program causing a calculation unit to execute a display state control method of controlling, by a calculation unit, a display state of an image displayed on a display unit corresponding to an input image signal, wherein
the display unit includes a plurality of pixels, and
the calculation unit shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.

11. A recording medium recorded with a display state control program according to claim 8 or 9 in a manner readable by a calculation unit, the display state control program causing a calculation unit to function as a display state controller for controlling a display state of an image corresponding to an input image signal, the image being displayed on a display unit that has a plurality of pixels, the display state controller comprising:
a shift controller that shifts predetermined regions to the other ends by performing: processing of enlarging the predetermined regions with one ends thereof as references so that an enlarged amount in one step is smaller than 1 pixel, in such a manner that the other ends opposing to the one ends are made apart from the one ends; and processing of reducing the predetermined regions with the other ends as references so that a reduced amount in one step is smaller than 1 pixel, in such a manner that the one ends are made closer to the other ends.
